(19) United States
(12) Patent Application Publication
(10) Pub. No.: US 2026/0349280 A1
(43) Pub. Date: Nov. 5, 2026

(54) DYNAMIC LENSES FOR CONTROL OF MYOPIA

(71) Applicant: SNOWFLAKE LABS LTD., Raanana (IL)

(72) Inventor: Yoav Yadin, Ganey Tikva (IL)

(21) Appl. No.: 19/488,865

(22) PCT Filed: May 29, 2024
(86) PCT No.: PCT/IB2024/055219

§ 371 Date: Dec. 1, 2025

Related U.S. Application Data
(60) Provisional application No. 63/505,429, filed on Jun. 1, 2023.
(60) Provisional application No. 63/505,430, filed on Jun. 1, 2023.

(51) Int. Cl. G02C 7/08; G02F 1/1343; G02F 1/1347

(52) U.S. Cl. CPC G02C 7/083; G02F 1/134309; G02F 1/1347; G02C 2202/20; G02C 2202/24

(57) ABSTRACT

Spectacles (20) for treatment of myopia include a spectacle frame (25) and first and second optical elements (22, 24), which have controllable optical phase profiles and are mounted in the spectacle frame so that when a user wears the spectacles, the first and second optical elements are positioned in respective lines of sight of the left and right eyes of the user. The spectacles further include control circuitry (26), which is configured to control the optical phase profiles of the first and second optical elements so as to apply optical perturbations to light that is incident on the left and right eyes through respective peripheral regions (39) of the first and second optical elements in a temporal alternation between the first and second optical elements.

### CROSS-REFERENCE TO RELATED APPLICATION

This application claims the benefit of U.S. Provisional Patent Application 63/505,429 and U.S. Provisional Patent Application 63/505,430, both filed Jun. 1, 2023, which are incorporated herein by reference.

### FIELD OF THE INVENTION

The present invention relates generally to optical devices, and particularly to electrically-tunable lenses.

### BACKGROUND

Myopia (near-sightedness) is a condition in which the human eye over-focuses light, creating an image in front of the retina instead of on the retina. Consequently, the image perceived on the retina is blurred. Several treatments have been studied for slowing down the progression of myopia (the increase over time of the optical power required to enable sharp view of far distances). These methods are generally referred to as “myopia progression control”, “myopia control” or “myopia management”. Research has shown that applying a perturbation to peripheral vision can slow the progression of myopia. The perturbation can consist of contrast reduction and/or blurring of the image, for example by applying defocus, all referred to hereafter as “perturbation”.

Electrically tunable lenses are optical elements having optical phase profiles that can be controlled by application of appropriate control voltages. The optical characteristics of such optical elements, such as the focal length and/or the location of the optical axis, can be adjusted during use, typically under electronic control. Such lenses may be used in a wide variety of applications, including particularly serving as vision aids.

U.S. Pat. No. 10,036,901, whose disclosure is incorporated herein by reference, describes an optical device. The optical device comprises an electro-optical layer having a local effective index of refraction at any given location within an active area of the layer that is determined by a voltage waveform applied across the layer at the location. The device further comprises a common electrode, positioned over the active area on a first side of the electro-optical layer, and an array of excitation electrodes, comprising parallel conductive stripes extending over the active area on a second side of the electro-optical layer, opposite the first side. The device also comprises control circuitry, which is connected to each of the excitation electrodes individually and is configured to control each of the excitation electrodes independently by applying respective control voltage waveforms to the excitation electrodes so as to tune a phase modulation profile of the electro-optical layer, and is configured to concurrently modify the respective control voltage waveforms applied to a plurality of the excitation electrodes, thereby modifying the phase modulation profile.

U.S. Pat. No. 10,466,391, whose disclosure is incorporated herein by reference, describes an electrically-tunable lens having an electro-optical layer and segmented excitation electrodes. The segmented electrodes are driven by control voltage waveforms to generate specified phase modulation profiles across the lens.

U.S. Patent Application Publication 2022/0214566, whose disclosure is incorporated herein by reference, describes an electrically-tunable lens, wherein drive signals are applied to generate a first phase modulation profile in a central zone that intercepts a line of sight of the user's eye and corrects the refractive error of the eye, and a second phase modulation profile in a peripheral zone causing a perturbation in the peripheral zone.

### SUMMARY

Embodiments of the present invention that are described hereinbelow provide improved electronically-tunable optical devices and methods for their operation.

There are therefore provided, in accordance with an embodiment of the invention, spectacles for treatment of myopia, including a spectacle frame and first and second optical elements, which have controllable optical phase profiles and are mounted in the spectacle frame so that when a user wears the spectacles, the first and second optical elements are positioned in respective lines of sight of the left and right eyes of the user. The spectacles further include control circuitry, which is configured to control the optical phase profiles of the first and second optical elements so as to apply optical perturbations to light that is incident on the left and right eyes through respective peripheral regions of the first and second optical elements in a temporal alternation between the first and second optical elements.

In one embodiment, the optical perturbations blur images seen by the eyes through the peripheral regions. For example, the optical perturbations may include a refractive power selected to defocus the images that are formed on retinas of the eyes, such as a positive refractive power.

In some embodiments, the optical perturbations reduce a contrast of images seen by the eyes through the peripheral regions.

In further embodiments, the control circuitry is configured to control the optical phase profiles so as to enable clear vision by the left and right eyes through respective central zones of both of the first and second optical elements while applying the optical perturbations in alteration in the peripheral regions. Additionally or alternatively, the respective central zones have fixed transverse dimensions. Alternatively, the respective central zones have variable transverse dimensions. Further alternatively, the optical phase profiles are controlled so that the respective central zones of the first and second optical elements have an identical transverse dimension while the optical perturbations in the peripheral regions are applied in the temporal alternation. Further alternatively, the control circuitry is configured to vary the transverse dimensions of the respective central zones of the first and second optical elements in alternation together with the temporal alternation of the optical perturbations in the peripheral regions.

In some embodiments, the control circuitry is configured to vary the transverse dimensions of the respective central zones of the first and second optical elements among at least three different values.

In further embodiments, the central zones of clear vision have a transverse dimension of at least 8 mm. Additionally or alternatively, the control circuitry is configured to control the optical phase profiles so that while the optical perturbations are applied to a peripheral region of one of the optical elements, the other of the optical elements provides clear vision within both the central and peripheral regions. Alternatively, the central zones of clear vision have a transverse dimension less than 2 mm.

In some embodiments, the control circuitry is configured to control the optical phase profiles so as to apply a myopic correction in the central zones.

In further embodiments, the control circuitry is configured to control the optical phase profiles so that the optical perturbations alternate at a rate of the temporal alternation between 10 Hz and once per day. Additionally or alternatively, the control circuitry is configured to control the optical phase profiles so that a period of the temporal alternation of the optical perturbations is between one minute and four hours.

In yet further embodiments, the temporal alternation between the first and second optical elements includes a gradual temporal transition of the perturbations in the respective peripheral regions, for example with a duration of at least 5 seconds.

In some embodiments, the control unit is configured to apply the optical perturbations to the first and second optical elements for different, respective periods of time.

In further embodiments, the control unit is configured to apply the optical perturbations to the first and second optical elements with different, respective strengths of perturbation.

In yet further embodiments, the first and second optical elements include compound lenses, each compound lens including a respective fixed lens component having a predefined refractive power and a respective optical phase modulator configured to apply the optical perturbations under control of the control circuitry.

In some embodiments, the spectacles include at least one sensor configured to output a signal indicative of an operating condition of the spectacles, wherein the control circuitry is configured to modify the optical phase profiles responsively to the signal. Additionally or alternatively, the signal is indicative of a distance to an object viewed by the user. Further additionally or alternatively, the signal is indicative of a gaze direction of the user. Further additionally or alternatively, the signal is indicative of a level of ambient light, and the control circuitry is configured to adjust a dimension of a clear central zone of the optical elements responsively to the level of ambient light.

There is also provided, in accordance with an embodiment of the invention, a method for treatment of myopia, including applying optical perturbations to light that is incident peripherally on left and right eyes of a user, such that the optical perturbations are applied in temporal alternation between the left and right eyes.

There are further provided, in accordance with an embodiment of the invention, spectacles for treatment of myopia, including a spectacle frame, and first and second optical elements, which are mounted in the spectacle frame so that when a user wears the spectacles, the first and second optical elements are positioned in respective lines of sight of the left and right eyes of the user. Each of the first and second optical elements includes at least one liquid crystal layer and conductive electrodes extending over opposing first and second sides of the at least one liquid crystal layer. The electrodes include an array of excitation electrodes, which include parallel conductive stripes extending along respective, mutually-parallel axes across the first side of the at least one liquid crystal layer. The spectacles further include control circuitry, which is coupled to apply respective control voltage waveforms to the excitation electrodes that are located in respective peripheral regions of the first and second optical elements so as to apply optical perturbations to light that passes through the peripheral regions in a temporal alternation between the first and second optical elements.

In a disclosed embodiment, in each of the first and second optical elements, the at least one liquid crystal layer includes first and second liquid crystal layers arranged in series, and the conductive electrodes include a first set of the parallel conductive stripes extending in a first direction over the first liquid crystal layer and a second set of the parallel conductive stripes extending in a second direction, orthogonal to the first direction, over the second liquid crystal layer.

In some embodiments, the control circuitry is configured to apply the control voltage waveforms to respective peripheral groups of the parallel conductive stripes in both of the first and second sets, whereby a rectangular central zone of each of the optical elements is unperturbed. In one embodiment, the control circuitry is configured to apply the control voltage waveforms to respective central groups of the parallel conductive stripes in both of the first and second sets so as to apply a myopic correction in the rectangular central zone.

In another embodiment, each of the conductive stripes is divided into two or more segments extending over respective, mutually disjoint parts of an axis of the stripe, and the control circuitry is coupled to apply the respective control voltage waveforms to respective peripheral segments of the excitation electrodes so as to apply the optical perturbations.

In a disclosed embodiment, the control circuitry is configured to apply the respective control voltage waveforms so that an optical phase profile of the liquid crystal layer emulates an array of microlenses in the peripheral regions. Alternatively, the control circuitry is configured to apply the respective control voltage waveforms so that an optical phase profile of the liquid crystal layer emulates a positive lens in the peripheral regions. Additionally or alternatively, the control circuitry is configured to apply the respective control voltage waveforms so that an optical phase profile of the liquid crystal layer emulates a Fresnel lens in the peripheral regions. Further alternatively, the control circuitry is configured to apply the respective control voltage waveforms so that the liquid crystal layer applies a pseudo-random phase pattern in the peripheral regions.

The present invention will be more fully understood from the following detailed description of the embodiments thereof, taken together with the drawings in which:

### BRIEF DESCRIPTION OF THE DRAWINGS

FIG. 1 is a schematic, pictorial illustration of spectacles for myopia control, in accordance with an embodiment of the invention;

FIG. 2 is a schematic side view of an electrically-tunable lens, in accordance with an embodiment of the invention;

FIG. 3A is a schematic pictorial view of an electrically tunable optical phase modulator, in accordance with an embodiment of the invention;

FIG. 3B is a schematic detail view of excitation electrodes in the optical phase modulator of FIG. 3A;

FIG. 3C is a schematic frontal view of a common electrode in the optical phase modulator of FIG. 3A;

FIG. 3D is a schematic pictorial illustration of a two-dimensional electrically tunable optical phase modulator, in accordance with an embodiment of the invention;

FIG. 4 is a schematic frontal view of an electrically-tunable lens used for myopia control, according to an embodiment of the invention;

FIG. 5 is a schematic frontal view of segmented excitation electrodes of an optical phase modulator, in accordance with an embodiment of the invention;

FIG. 6 is a schematic frontal view of the optical phase modulator of FIG. 5 showing electrical control circuits of the segmented electrodes, in accordance with an embodiment of the invention;

FIGS. 7A and 7B are schematic frontal views of the left and right lenses of the spectacles of FIG. 1 in two respective periods of time, in accordance with an embodiment of the invention;

FIGS. 8A, 8B and 8C are schematic frontal views of the left and right lenses of the spectacles of FIG. 1 in three respective periods of time, in accordance with another embodiment of the invention;

FIG. 9A is a schematic plot of the refractive power (in diopters) of an electrically-tunable optical phase modulator as a function of location across a lens, in accordance with an embodiment of the invention;

FIG. 9B is a schematic plot of the phase modulation profile applied by the optical phase modulator of FIG. 9A (in arbitrary units of phase, AU) as a function of location across the lens, in accordance with an embodiment of the invention;

FIG. 9C is a schematic plot of the phase modulation profile applied by an optical phase modulator as a function of location across a lens, in accordance with another embodiment of the invention;

FIG. 10 is a schematic plot of a phase modulation profile applied by an electrically-tunable optical phase modulator, in accordance with another embodiment of the invention; and

FIG. 11 is a schematic plot of a phase modulation profile applied by an electrically-tunable optical phase modulator, in accordance with yet another embodiment of the invention.

### DETAILED DESCRIPTION OF EMBODIMENTS

### Overview

The above-mentioned U.S. Patent Application Publication 2022/0214566 describes lenses for use in myopia control with a clear, optically corrected central zone and a perturbed peripheral region generated on each lens. The central zone is clear for permitting an unperturbed view of objects by the user, although it may incorporate a refractive correction according to the user's prescription. The peripheral region, surrounding the entire clear zone or a part of it, has its refractive properties modified to perturb the peripheral vision of the user by blurring the peripheral images in the user's eyes or by reducing the contrast of these images. Control of myopia requires that a sufficient portion of the peripheral vision is perturbed, thus limiting the available area for the central zone.

Spectacle lenses in which the clear central zone of each lens has a fixed position will work satisfactorily as long as the line of sight of each eye is intercepted by the respective clear zone. However, as the user views different parts of a wider scene, the user's eyes rotate and may shift the respective lines of sight from the fixed central zone into the peripheral region, thus blurring the user's vision. Thus, the field of view of the user (the angular range in which the user can rotate his eyes while still experiencing clear vision) is limited by the size of the central zone combined with the distance of the spectacle lenses from the pupils of the eyes. The transverse dimension of the fixed, clear central zone should be large enough to enable the user to see clearly straight ahead and also when looking to the sides over a reasonable range of angles. Otherwise, the user might feel discomfort due to the small field of view (“tunnel vision”), and consequently even stop wearing the spectacles. On the other hand, the central zone should be small enough to leave sufficient space for the peripheral perturbation. Increasing the size of the central zone to reduce tunnel vision and associated discomfort reduces the area of perturbation and may decrease the therapeutic efficacy of the spectacles.

As noted in the above-mentioned U.S. Patent Application Publication 2022/0214566, the electrically tunable lenses may be controlled to shift the central zone of each spectacle lens in conjunction with the peripheral region in order to accommodate changes in the direction of the line of sight. The control of the position of the central zone, however, may require the use of an eye tracker or other device capable of detecting the direction of the lines of sight of the user's eyes. While this approach can mitigate the problem of the narrow field of view due to the perturbed peripheral region, the required tracking device will increase the complexity, cost, and power consumption of the spectacles.

Embodiments of the present invention that are described herein address the conflicting requirements of a large field of view and treatment efficacy by dynamically changing the perturbation in alternation between the left and right eyes. The pair of electrically tunable spectacle lenses is controlled so that at any given time, one eye sees through a large clear central zone (or even a central zone covering the entire lens, i.e. no perturbation), while the opposite eye has a smaller clear central zone (or even no central zone), resulting in perturbation over a large area of the retina. The user thus sees clearly with one eye over a large field of view, while the other eye experiences considerable perturbation. Switching this arrangement in alternation between the eyes ensures that both eyes experience peripheral perturbation, while simultaneously permitting each eye, in its turn, to see clearly. This kind of alternation gives the user a subjective feeling of clear vision while providing treatment for myopia.

In the disclosed embodiments, spectacles for treatment of myopia comprise a spectacle frame, first and second optical elements, and control circuitry. The optical elements have controllable optical phase profiles and are mounted in the spectacle frame so that when a user wears the spectacles, the first and second optical elements are positioned in respective lines of sight of the left and right eyes of the user. The control circuitry controls the optical phase profiles of the first and second optical elements so as to apply optical perturbations to light that is incident on the left and right eyes through respective peripheral regions of the first and second optical elements in a temporal alternation between the first and second optical elements.

In some embodiments, each of the first and second optical elements comprises at least one liquid crystal layer and conductive electrodes extending over opposing sides of the at least one liquid crystal layer. The electrodes comprise an array of excitation electrodes, which comprise parallel conductive stripes extending along respective, mutually-parallel axes across one side of the at least one liquid crystal layer. Control circuitry applies respective control voltage waveforms to the excitation electrodes that are located in respective peripheral regions of the optical elements so as to apply optical perturbations in the desired temporal alternation between the first and second optical elements.

Alternatively, other means may be applied to perturb the peripheral regions of the left and right optical elements in alternation. For example, optical or mechanical perturbations may be applied to blur or otherwise defocus the user's vision or to reduce the optical contrast in the peripheral regions. Alternation of the perturbation between the left and right eyes using any suitable means of perturbation can be effective in controlling myopia and is considered to be within the scope of the present invention.

### System Description

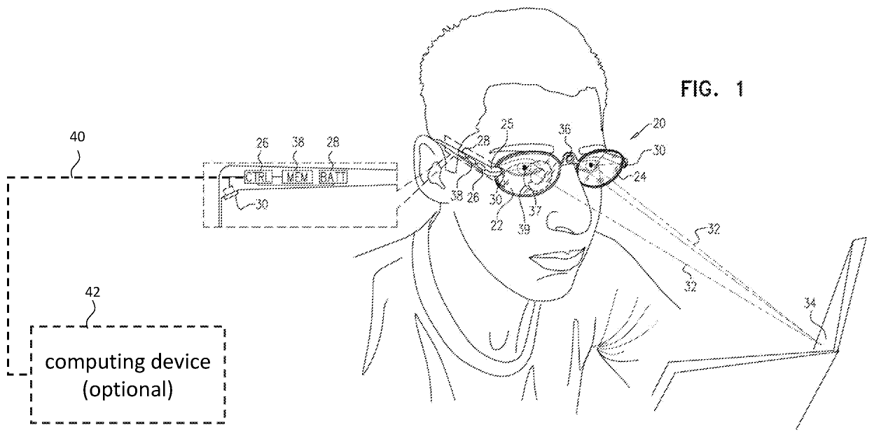

FIG. 1 is a schematic, pictorial illustration of spectacles 20 for myopia control, in accordance with an embodiment of the invention. Spectacles 20 comprise electrically-tunable lenses 22 and 24, mounted in a frame 25. The optical properties of the lenses, as will be detailed hereinbelow, are controlled by control circuitry 26, which is powered by a battery 28 or other power source. Control circuitry 26 typically comprises an embedded microprocessor with hard-wired and/or programmable logic components and suitable interfaces for carrying out the functions that are described herein. These and other elements of spectacles 20 are typically mounted on or in frame 25, or may alternatively be contained in a separate unit (not shown) connected by wire to frame 25.

Control circuitry 26 may additionally be coupled by a wire link 40 or a wireless link (such as WiFi) to an external computing device 42, such as a computer, a tablet, or a mobile phone. Computing device 42 typically comprises, with variations depending on the type of the device, a microprocessor with logical components, an internal memory, a display and input/output devices. Computing device 42 is configured to upload instructions to control circuitry 26 and to download data relating to the functions of spectacles 20 from the control circuitry.

Each lens 22 and 24 comprises a central zone 37 and a peripheral region 39. For the sake of clarity, only central zone 37 and peripheral region 39 of lens 22 are shown in FIG. 1. In the pictured example, peripheral region 39 is annular, extending 360° around circular central zone 37, but alternatively peripheral region 39 may extend around a smaller angle of arc. Central zone 37 and peripheral region 39 may alternatively have different shapes, such as a rectangle or square shape. The respective central zones 37 of lenses 22 and 24 may have equal or different transverse dimensions, and these transverse dimensions may be fixed or variable, as will be further detailed hereinbelow.

For myopia control, control circuitry 26 applies control waveforms to lenses 22 and 24 according to phase modulation profile parameters that are stored in a memory 38. These parameters indicate the characteristics that are to be applied in respective central zones 37 and peripheral regions 39 of the lenses. As noted earlier, the phase modulation profile of central zone 37 in each lens 22, 24 is typically selected so that the central zone provides a clear vision for the respective eye, with a possible correction of the refractive error of the eye. The parameters for each peripheral region 39 are selected to perturb the peripheral vision of the respective eye, while the extents of the peripheral regions (and consequently the extent of the respective central zone) are changed dynamically in alternation between the left and the right eyes. Schemes for alternation between the eyes are further detailed hereinbelow.

In some embodiments, spectacles 20 may additionally comprise one or more sensors 30, which output a signal indicative of an operating condition of the spectacles. Control circuitry 26 modifies the optical phase profiles responsively to the signal. For example, sensor 30 may sense the gaze direction of a line of sight 32 of the eyes of the person wearing the spectacles, and possibly also the distance from the eyes to an object 34 viewed by the person, as well as the level of ambient illumination. Further details of this sort of sensing are described in the above-mentioned U.S. Patent Application Publication 2022/0214566. Alternation of the perturbation between lenses 22 and 24, however, may obviate the need to control the lenses according to the sensor readings.

Additionally, control circuitry 26 may adjust the transverse dimension of clear central zone 37 of the optical elements responsively to the measured level of ambient light.

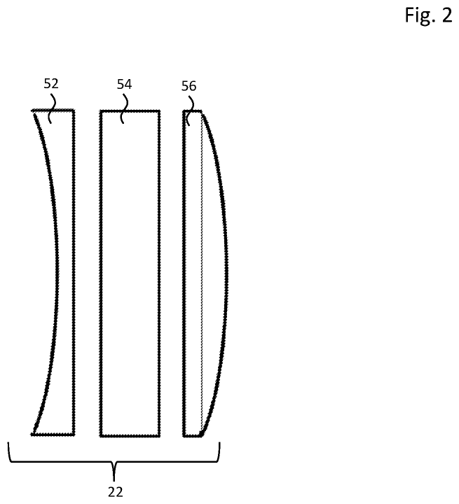

FIG. 2 is a schematic side view of electrically-tunable lens 22, in accordance with an embodiment of the invention. Lens 24 is typically of similar design.

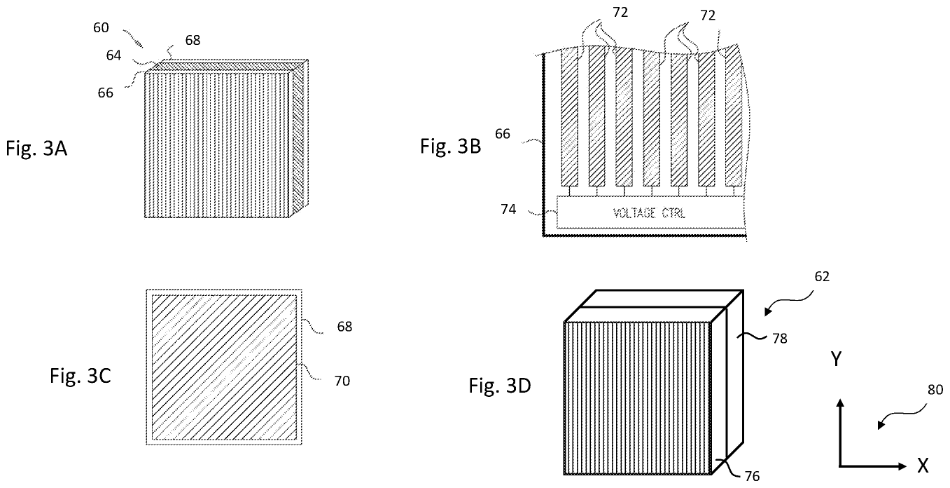

In the pictured embodiment, lens 22 is a compound lens, which comprises multiple elements: Fixed lenses 52 and 56, typically made from glass or plastic, provide a baseline refractive power, which is modified dynamically by an electrically-tunable phase modulator 54, further detailed in FIGS. 3A-3D and FIGS. 5-6 hereinbelow. Although electrically-tunable phase modulator 54 is shown as a flat panel, it can also be curved in one or two dimensions (cylindrical or spherical), on one or both sides.

Although fixed lenses 52 and 56 are shown as being physically separate from tunable phase modulator 54, in practice these components are typically encapsulated in a single package in the form of a spectacle lens. (For this reason, lens 22 itself can be considered an electrically-tunable lens.) Thus, the total refractive power of lens 22, over any zone within the area of the lens, will typically be a sum of the fixed refractive powers of lenses 52 and 56, together with the variable refractive power (or other phase modulation profile) applied by phase modulator 54. Alternatively, lens 22 may comprise only electrically-tunable elements, and fixed lenses 52 and 56 may not be needed, particularly when the magnitude of the refractive correction is small.

FIGS. 3A-3C illustrate schematically a one-dimensional optical phase modulator 60, while FIG. 3D is a pictorial illustration of a two-dimensional optical phase modulator 62 comprising two one-dimensional phase modulators 60, in accordance with an embodiment of the invention. (The terms “one-dimensional” and “two-dimensional” refer to the characteristics of the phase profiles applied by the optical phase modulators.) FIG. 3A is a pictorial illustration of one-dimensional phase modulator 60, while FIGS. 3B and 3C are side views of opposing sides of the phase modulator.

As described in the above-referenced U.S. Pat. No. 10,036,901, phase modulator 60 comprises an electro-optical layer 64, such as a liquid-crystal layer, which is typically contained by suitable encapsulation, as is known in the art. Layer 64 has a local effective index of refraction at any given location within its active area (for example, within the area of the layer that actually contains the liquid crystal) that is determined by the voltage applied across the layer at that location.

Transparent substrates 66 and 68, such as glass blanks, are positioned on opposing sides of layer 64, and respective excitation electrodes are disposed on the substrates as shown in FIGS. 3B and 3C. The electrodes comprise a transparent, conductive material, such as indium tin oxide (ITO), as is known in the art. Alternatively, non-transparent electrodes may be used, as long as they are thin enough so that they do not cause disturbing optical effects. A common electrode 70 on substrate 68 is positioned over the active area of layer 64 on one side. Although this common electrode is shown as a monolithic rectangle, it may alternatively have any suitable shape that sufficiently covers the active area of layer 64. An array of excitation electrodes 72, comprising parallel stripes of the transparent conductive material on substrate 66, extends over the active area on the opposite side of layer 64. (“Parallel” in this context may include, as well, electrodes that deviate in angle by several degrees.) The parallel stripes are oriented vertically in this example, i.e., in the Y-direction with reference to a coordinate system 80. Although for the sake of visual clarity, only a few electrodes 72 are shown in FIG. 3B, in practice, a larger number of electrodes may be used for good optical quality. For example, modulator 60 may comprise about 20 stripe electrodes, or possibly at least 100 stripe electrodes for excitation, or even 400 or more.

Control circuitry 74 is coupled to apply respective control voltages to excitation electrodes 72, relative to the common voltage level of electrode 70. Control circuitry 74 typically comprises amplifiers and/or switches, as are known in the art, which control either the amplitude or the duty cycle, or both, of the voltage that is applied to each electrode 72. The pattern of amplitudes and/or duty cycles applied to the electrodes determines the phase modulation profile of layer 64. The circuit components in circuitry 74 are typically fabricated as a silicon chip, which is then glued onto substrate 66, as shown in FIG. 3B. Alternatively, some or all of the components of circuitry 74 may be formed on a separate chip and connected to substrate 66 by suitable bonding wires or other connections. In either case, the control circuitry can be located at the side of the array of electrodes, as shown in FIG. 3B, and there is no need for any parts of the control circuitry to be located over the active area of layer 64.

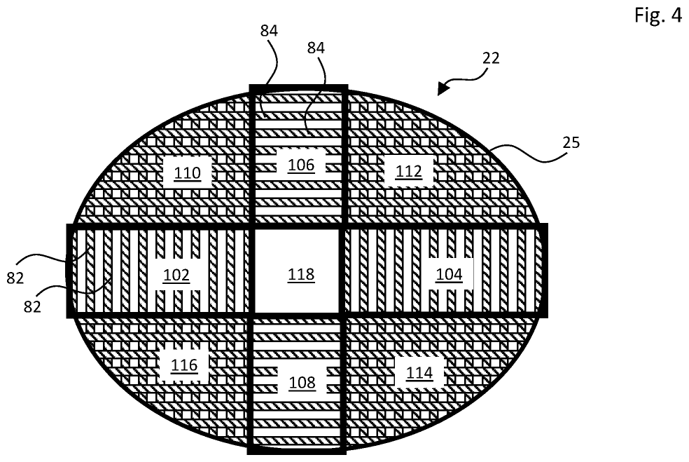

Circuitry 74 is able to modify the control voltages applied to each of a set of the excitation electrodes 72 (which may include all of the electrodes) concurrently and independently. For example, circuitry 74 may update the control voltages applied to all the odd electrodes in the array alternately with all the even electrodes. This sort of approach scales readily to large electrode counts, and can thus be used to create electrically-tunable optical systems with high pixel counts and fine resolution. Another example of selective application of control voltages is shown in FIG. 4 hereinbelow.

FIG. 3D is a pictorial illustration of two-dimensional phase modulator 62, comprising two one-dimensional phase modulators 76 and 78. Each of the one-dimensional modulators is identical or similar to modulator 60, with the excitation electrodes of modulator 76 oriented in the Y-direction and the excitation electrodes of modulator 78 oriented in the X-direction. The two one-dimensional modulators can be glued together. Moreover, they may be oriented “back-to-back” and share a joint common electrode, such as electrode 70.

Two-dimensional phase modulator 62 may be used as phase modulator 54 for lens 22 (FIG. 2). When using a birefringent liquid crystal, lens 22 may comprise a polarizer, as is known in the art (omitted from the figures for simplicity), in order to select the polarization of the light that is to be passed and refracted by the liquid-crystal layers of phase modulator 62. When phase modulator 62 is used within spectacles 20 as described hereinabove, the respective control circuitries, such as circuitry 74 of modulator 60, are coupled to control circuitry 26 of the spectacles for receiving control voltage waveforms.

As further described in the above-referenced U.S. Patent Application Publication 2022/0214566, phase modulator 54 may comprise four optical phase modulators (not shown in the figures), combining phase modulation in two orthogonal directions with two orthogonal polarizations for each direction.

In alternative embodiments, other types of phase modulators may be used for lens 22, such as the two-dimensional phase modulator shown in FIGS. 3A-3D in U.S. Pat. No. 10,036,901, or modulators with circular electrodes.

FIG. 4 is a schematic frontal view of electrically-tunable lens 22 for myopia control, according to an embodiment of the invention. In this embodiment, modulator 54 may comprise two-dimensional phase modulator 62 (FIG. 3D), for example.

As in FIG. 1, lens 22 is mounted in frame 25, with only the part of the frame around the lens shown. The two orthogonal one-dimensional modulators 76 and 78 of modulator 62 comprise respective vertical excitation electrodes 82 and horizontal excitation electrodes 84. For myopia control, only peripheral groups of electrodes 82 and 84, i.e., those electrodes that do not cross a central area 118 of lens, are excited (have control voltages applied) by control circuitry 26, whereas central groups of the electrodes, i.e., the electrodes that cross the central area, are not excited. For clarity, this arrangement is presented in FIG. 4 by showing only the excited electrodes. The selective excitation of electrodes 82 and 84 divides lens 22 into nine areas, based on the type of phase modulation:
In areas 102 and 104, where only the vertical (Y) electrodes 82 are excited, the phase is modulated in the horizontal (X) direction.
In areas 106 and 108, where only horizontal (X) electrodes 84 are excited, the phase is modulated in the vertical (Y) direction.
In areas 110, 112, 114, and 116, where both X- and Y-electrodes are excited, the phase is modulated in both the X- and Y-directions.
In area 118, where no electrodes are excited, there is no phase modulation.

Thus, areas 102-116 perturb the light impinging on lens 22 and define perturbed peripheral region 39 (FIG. 1), whereas area 118 permits clear vision and defines central zone 37. By selecting larger or smaller sets of electrodes 82 and 84 to excite, control circuitry 26 can decrease or increase the size of central area 118 (and can do so in alternation between the left and right eyes, as explained above).

By exciting other groups of X- and/or Y-electrodes, central zone 37, i.e., area 118, may be shifted laterally on lens 22. In spectacles 20 comprising optional eye trackers 30, the signals from the eye trackers may be used to control the lateral shift of central zone 37, as noted hereinabove.

### Segmented Electrodes

In some cases it may be desirable to segment the excitation electrodes of an electrically-tunable lens, as described in the above-referenced U.S. Pat. No. 10,466,391. Control strategies as described hereinbelow may be used to enable modifying the phase profile of the lens in a flexible fashion. For example, the refractive power of the central zone may be adjusted according to a refractive correction required by a user's eye, while the perturbation of the peripheral region may be selected for maximal therapeutic efficacy.

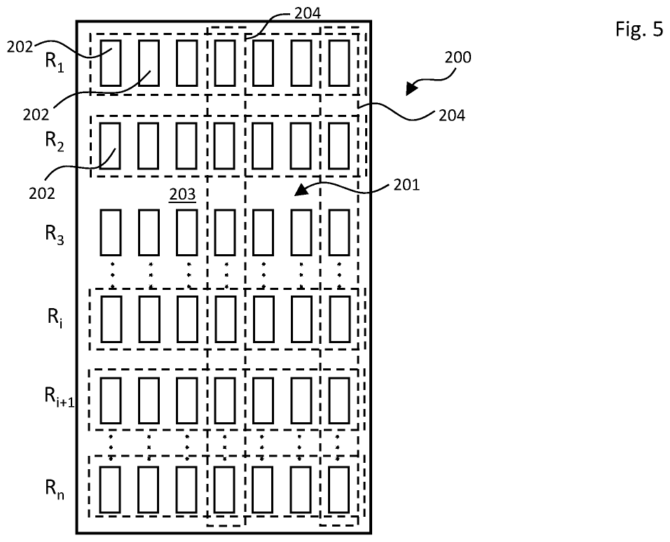

FIG. 5 is a schematic side view of segmented excitation electrodes 202 of an optical phase modulator 200, in accordance with an embodiment of the invention.

An array 201 of excitation electrodes comprises parallel conductive stripes 204 extending along respective, mutually-parallel axes across a transparent substrate 203 over the active area of an electro-optical layer, such as a liquid crystal. Segmented electrodes 202 are formed by dividing each stripe 204 into n segment groups labeled R₁, R₂, . . . , Rᵢ, Rᵢ₊₁, . . . , Rₙ, where n and i are integers with 1≤i≤n. For myopia control, appropriate control voltage waveforms are applied to the segments in the peripheral part of array 201 in order to perturb vision, while the segments in the central part of the array permit clear vision. As in the preceding embodiments, the perturbation is applied in alternation between the left and right eyes.

Segments 202 may be located on a Cartesian grid, with a grid pitch of 1 mm in both X- and Y-directions. Grids of other (non-Cartesian) arrangements and other grid pitches may alternatively be used. In order to achieve good optical quality for phase modulator 200, the gaps between segments 202 are typically much smaller than the lengths of the segments themselves. The segments can all be of similar lengths, as in the example shown in FIG. 5, or different segments can have different lengths, both within each stripe and between different stripes.

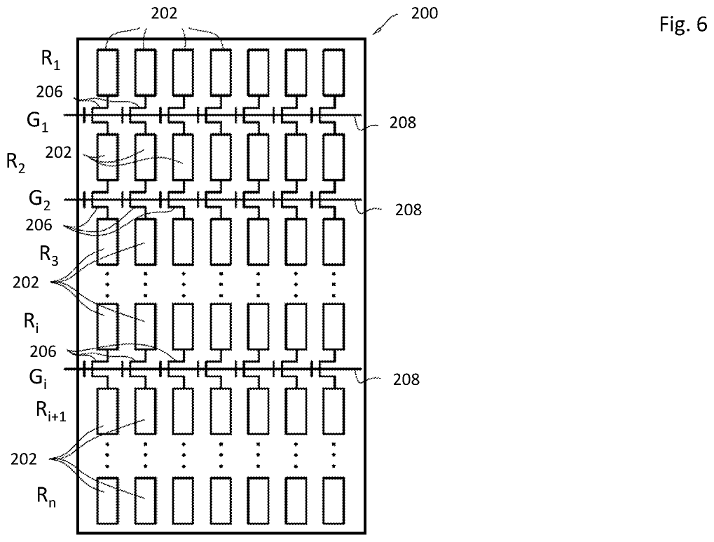

FIG. 6 is a schematic side view of phase modulator 200 showing electrical control of segmented electrodes 202, in accordance with an embodiment of the invention.

Segments 202 are interconnected in series by switches 206, labeled G₁, G₂, . . . , Gᵢ, . . . , Gₙ₋₁, such as suitable thin-film transistors. Integer n has the same value as in FIGS. 5 and 1≤i≤n−1. Control lines 208 are connected to actuate corresponding rows of switches 206 across all of the stripes, with a single control line connected to each switch Gᵢ over all of the stripes. By actuating the appropriate control lines, control circuitry 26 (FIG. 1) is thus able to electrically join or separate each segment 202 to or from its neighbors in all of the stripes simultaneously.

As detailed in the above-referenced U.S. Pat. No. 10,466,391, control circuitry 26 is typically connected to apply the control voltage waveforms to one or both ends of each of conductive stripes 204, for example, to segment group R₁ and possibly to segment group Rₙ in each stripe. To apply different, respective control voltage waveforms to different segment groups, the control circuitry can actuate the appropriate switches 206 and modify the control voltage waveforms applied to the respective ends of the conductive stripes 204. To enlarge or reduce the size of the clear central area of the lens, different switches 206 are turned on and off so as to activate or deactivate the perturbation applied by segments 202 in the central area.

Phase modulator 200 may be used as two-dimensional phase modulator 54 for lens 22 (FIG. 2). In an alternative embodiment, two such phase modulators in series and rotated 90 degrees with respect to each other around an axis perpendicular to the planes of the modulators may advantageously add flexibility to the phase modulation of lens 22.

### Myopia Control Schemes

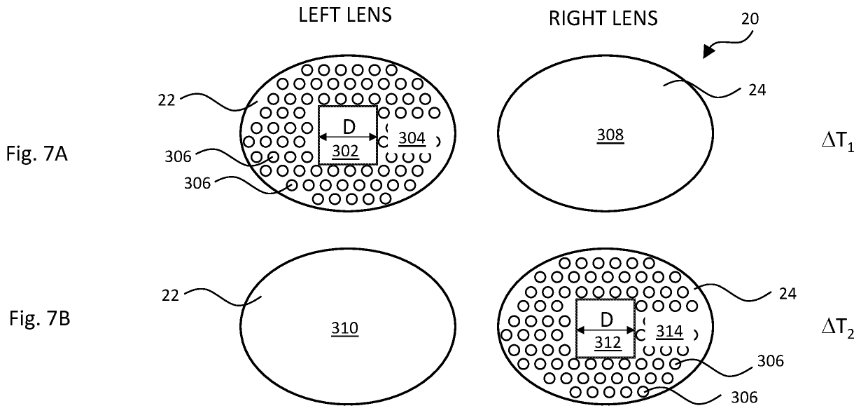

FIGS. 7A and 7B are schematic frontal views of left and right lenses 22 and 24 of spectacles 20 in two respective periods of time, in accordance with an embodiment of the invention.

FIG. 7A shows left and right lenses 22 and 24 during a time period ΔT₁. During this time period, phase modulator 54 of lens 22 is driven by control circuitry 26 so that the lens has a square central zone 302 of transverse dimension D, and a peripheral region 304 with a phase profile that emulates the effect of an array of microlenses 306, while right lens 24 has a central zone 308 filling the entire lens, i.e., the right lens has no peripheral perturbation. Central zone 302 has either no phase modulation or a phase modulation providing the central zone with refractive power for correcting the vision in the user's left eye. Thus, the user has clear vision of external objects through central zone 302. Microlenses 306 have a refractive power different from that of central zone 302, for example a positive refractive power, thus perturbing the peripheral field of vision of the left eye. This perturbation blurs the vision in the peripheral field of view and/or reduces the contrast of the viewed object for the purpose of myopia control.

FIG. 7B shows left and right lenses 22 and 24 during a time period ΔT₂, following time period ΔT₁. During time period ΔT₂, control circuitry 26 drives lenses 22 and 24 in phase modulations opposite to that of FIG. 7A: Lens 22 has an unmodulated (clear) central zone 310 filling the entire lens, whereas lens 24 has a square central zone 312 of transverse dimension D and a peripheral region 314 emulating an array of microlenses 306.

Control circuitry 26 switches between time periods ΔT₁ and ΔT₂ continually in alternation. Switching between the states of FIGS. 7A and 7B may be done between once every few minutes to once every few hours (minutes≤ΔT₁, ΔT₂≤hours), but can also be done at a rate as fast as 10 Hz, or at a rate as slow as once a day (0.1 sec≤ΔT₁, ΔT₂≤1 day), or at an intermediate rate, such as between once a minute and once every 4 hours (1 minute≤ΔT₁, ΔT₂≤4 hours). Time periods ΔT₁ and ΔT₂ may be either of equal length or different, wherein the lengths may be determined based on therapeutic considerations.

Peripheral vision is sensitive to abrupt changes for detecting movement in the real world. When the switching between the states is done at a rate slower than 0.2 Hz (5 sec≤ΔT₁, ΔT₂), the switching itself can be done gradually so as not to trigger motion detection in the user's peripheral field of view. A gradual switching is implemented by including a gradual transition between the two time periods ΔT₁, ΔT₂, wherein the length of the gradual transition is typically more than 5 seconds.

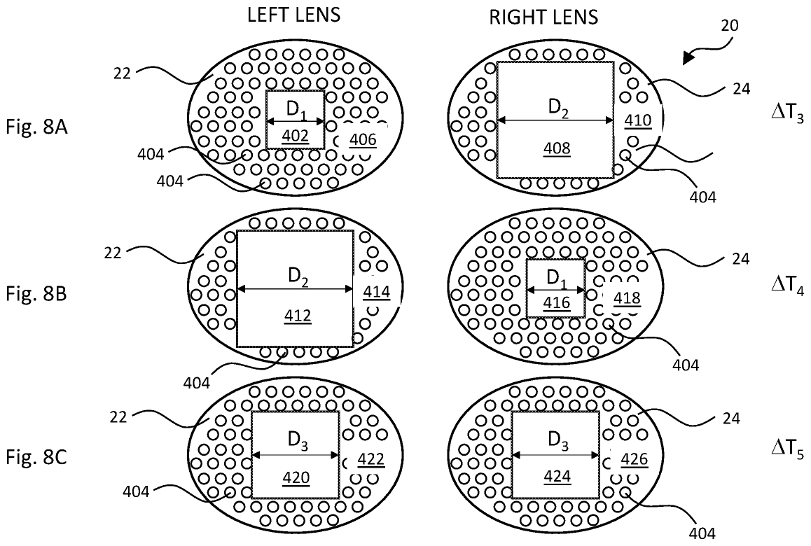

In the pictured embodiments, central zones 302 and 312 are squares with the same transverse dimension D. In alternative embodiments, the central zones may have a rectangular shape or some other shape within the limitations of the structure and driving strategy of the excitation electrodes. A typical transverse dimension of the central zone (inside a peripheral region) may be 8 mm, although smaller or larger transverse dimensions may be used. For example, the transverse dimension D may be less than 2 mm, or even zero, in which case the peripheral region fills the entire optical element, i.e., the entire optical element is perturbed. The transverse dimensions may also be different for left lens 22 and right lens 24. Furthermore, instead of the central zone filling the entire lens, such as, for example, central zone 308 in time period ΔT₁, the central zone may be larger than central zone 302 but still surrounded by a perturbed peripheral region. This embodiment is further exemplified in FIGS. 8A-8C hereinbelow.

Although in the pictured embodiments, the perturbation in peripheral regions 304 and 314 is accomplished by emulating arrays of microlenses 306, in alternative embodiments other sorts of perturbations may be applied. For example, the peripheral regions may be driven to apply continuous positive refractive power or random phase modulation. The optical properties of the perturbing phase modulation may be adjusted to different strengths of perturbation between the left and right eyes, with “different strength of perturbation” meaning different defocus power or random phase leading to different amounts of blurring and/or loss of contrast.

In the pictured embodiment, central zones 302 and 312 are centered in respective lenses 22 and 24. In an alternative embodiment, central zones 302 and 312 may be shifted laterally from the central position, for example based on inputs from sensors 30 (FIG. 1).

FIGS. 8A, 8B and 8C are schematic frontal views of left and right lenses 22 and 24 of spectacles 20 in three respective periods of time, in accordance with another embodiment of the invention.

Control circuitry 26 cycles left and right lenses 22 and 24 through three configurations in alternation during consecutive time periods ΔT₃, ΔT₄, and ΔT₅, with the parameters of these configurations summarized in Table 1 hereinbelow.

TABLE 1
Configurations of lenses 22 and 24

| | | Left lens 22 | | | Right lens 24 | | |
|---|---|---|---|---|---|---|---|
| | | | Central | | | Central | |
| | Time | Central | zone | Peripheral | Central | zone | Peripheral |
| FIG. | period | zone # | dimension. | region # | zone # | dimension. | region # |
| 8A | ΔT₃ | 402 | D₁ | 406 | 408 | D₂ | 410 |
| 8B | ΔT₄ | 412 | D₂ | 414 | 416 | D₁ | 418 |
| 8C | ΔT₅ | 420 | D₃ | 422 | 424 | D₃ | 426 |

All peripheral regions 406, 410, 414, 418, 422, and 426 emulate arrays of microlenses 404, similar to microlenses 306 in FIGS. 7A-7B. The transverse dimensions D₁, D₂, and D₃ of central zones in Table 1 may be, for example D₁=8 mm, D₂=16 mm, and D₃=12 mm. In alternative embodiments, other dimensions may be used.

The time periods ΔT₃, ΔT₄, and ΔT₅ have values similar to ΔT₁ and ΔT₂ in FIGS. 7A-7B.

### Tunable Lens Profiles for Myopia Control

The figures that follow show optical profiles of refractive power and phase shift of electrically-tunable phase modulator 54 as a function of location along a line running across the lens, for example along the horizontal (X) axis, crossing central zone 37 and peripheral region 39. Alternatively, similar sorts of profiles may be generated in electrically-tunable lenses of other sorts.

For the purpose of myopia control, central zone 37 is assumed in these examples to have a transverse dimension of 4 mm, although larger or smaller dimensions may be used. For example, control circuitry 26 may increase or decrease the size of central zone 37 as a function of pupil size, as measured by eye trackers 30 or according to ambient light measurement. As in the preceding embodiments, the dimension of central zone 37 increases and decreases in alternation between the left and right eyes. The perturbation applied in peripheral regions 39 may also vary between the eyes.

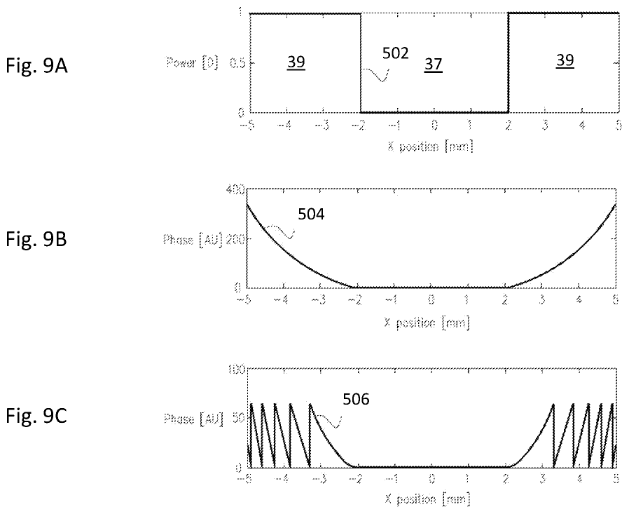

FIG. 9A is a schematic plot 502 of the refractive power (in diopters) of electrically-tunable optical phase modulator 54 of lens 22 (FIG. 2) as a function of location across the lens, in accordance with an embodiment of the invention. In this example, it is assumed that fixed lenses 52 and 56 provide a baseline refractive power equal to the refractive correction required by the user, for instance −2D (two diopters, with negative sign). Therefore, control circuitry 26 drives phase modulator 54 to apply no additional refractive power in central zone 37. In peripheral region 39, phase modulator 54 applies an additional refractive power of +1D, so that the net refractive power of lens 22 is −1D. Other, stronger refractive powers can be used as well. The reduced magnitude of the refractive power in the peripheral region and concomitant blurring of the peripheral vision can be useful in myopia control.

FIG. 9B is a schematic plot 504 of the phase modulation profile applied by phase modulator 54 (in arbitrary units of phase, AU) as a function of location across lens 22, in accordance with an embodiment of the invention. In this case, the phase modulation profile represented by plot 504 varies continuously across peripheral region 39 in the horizontal direction relative to the line of sight, which is located at the origin X=0. A similar profile may be applied in the vertical direction.

FIG. 9C is a schematic plot 506 of the phase modulation profile applied by phase modulator 54 as a function of location across lens 22, in accordance with another embodiment of the invention. The phase modulation profile in this case comprises a pattern of peaks and troughs that alternate across peripheral region 39 in a transverse direction relative to the line of site. The pattern is selected so that the phase modulation profile emulates a Fresnel lens. The Fresnel lens achieves the same refractive power (+1D) as does the smooth profile of plot 504, but with a lower maximum phase shift. The use of the Fresnel profile, as opposed to a smooth profile, thus makes it possible to use a thinner electro-optical layer in phase modulator 54, as well as lower voltages in driving the phase modulator.

For shifting central zone 37, for example along the X-axis toward negative X-values, plots 502, 504, and 506 are shifted accordingly.

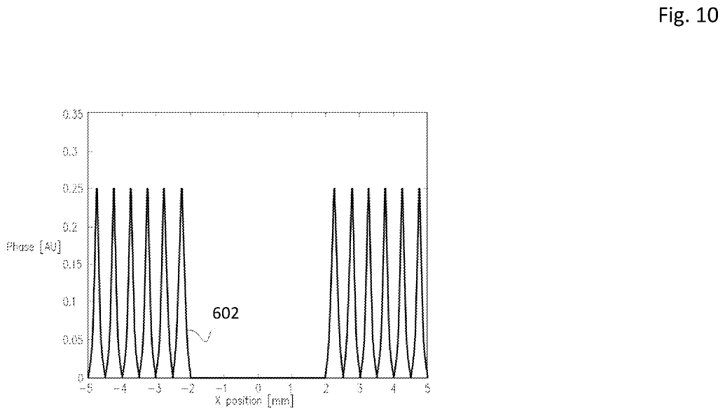

FIG. 10 is a schematic plot 602 of a phase modulation profile applied by phase modulator 54 as a function of location across a lens, in accordance with another embodiment of the invention. Here, too, the phase shift is plotted in arbitrary units. The phase modulation profile of plot 602 comprises a pattern of alternating peaks and troughs that emulate an array of microlenses in peripheral region 39. For example, the refractive power of each microlens can range between +1D and +8D.

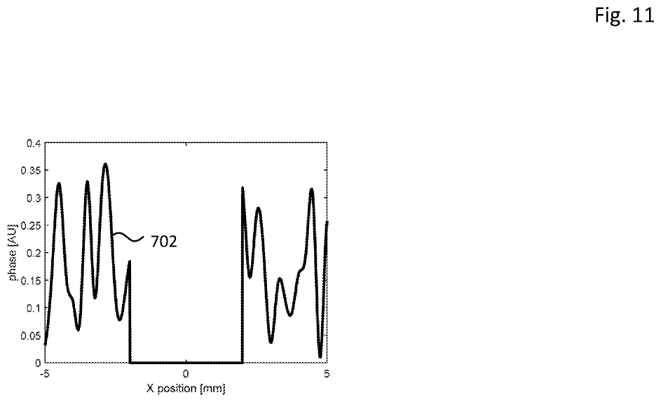

FIG. 11 is a schematic plot 702 of a phase modulation profile applied by phase modulator 54 as a function of location across the lens, in accordance with yet another embodiment of the invention. The phase shift is plotted in arbitrary units. The phase modulation profile of plot 702 comprises a pseudo-random phase pattern for blurring and/or lowering the contrast of the peripheral vision.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Spectacles for treatment of myopia, comprising:
a spectacle frame;
first and second optical elements, which have controllable optical phase profiles and are mounted in the spectacle frame so that when a user wears the spectacles, the first and second optical elements are positioned in respective lines of sight of the left and right eyes of the user; and
control circuitry, which is configured to control the optical phase profiles of the first and second optical elements so as to apply optical perturbations to light that is incident on the left and right eyes through respective peripheral regions of the first and second optical elements in a temporal alternation between the first and second optical elements.

2. The spectacles according to claim 1, wherein the optical perturbations blur images seen by the eyes through the peripheral regions.

3. The spectacles according to claim 2, wherein the optical perturbations comprise a refractive power selected to defocus the images that are formed on retinas of the eyes.

4. The spectacles according to claim 3, wherein the refractive power is positive.

5. The spectacles according to claim 1, wherein the optical perturbations reduce a contrast of images seen by the eyes through the peripheral regions.

6. The spectacles according to claim 1, wherein the control circuitry is configured to control the optical phase profiles so as to enable clear vision by the left and right eyes through respective central zones of both of the first and second optical elements while applying the optical perturbations in alteration in the peripheral regions.

7. (canceled)

8. The spectacles according to claim 6, wherein the respective central zones have variable transverse dimensions.

9. (canceled)

10. The spectacles according to claim 8, wherein the control circuitry is configured to vary the transverse dimensions of the respective central zones of the first and second optical elements in alternation together with the temporal alternation of the optical perturbations in the peripheral regions.

11-14. (canceled)

15. The spectacles according to claim 6, wherein the control circuitry is configured to control the optical phase profiles so as to apply a myopic correction in the central zones.

16. The spectacles according to claim 1, wherein the control circuitry is configured to control the optical phase profiles so that the optical perturbations alternate at a rate of the temporal alternation between 10 Hz and once per day.

17. The spectacles according to claim 16, wherein the control circuitry is configured to control the optical phase profiles so that a period of the temporal alternation of the optical perturbations is between one minute and four hours.

18-21. (canceled)

22. The spectacles according to claim 1, wherein the first and second optical elements comprise compound lenses, each compound lens comprising a respective fixed lens component having a predefined refractive power and a respective optical phase modulator configured to apply the optical perturbations under control of the control circuitry.

23. The spectacles according to claim 1, and comprising at least one sensor configured to output a signal indicative of an operating condition of the spectacles, wherein the control circuitry is configured to modify the optical phase profiles responsively to the signal.

24-26. (canceled)

27. A method for treatment of myopia, comprising applying optical perturbations to light that is incident peripherally on left and right eyes of a user, such that the optical perturbations are applied in temporal alternation between the left and right eyes.

28. The method according to claim 27, wherein applying the optical perturbations comprises blurring images seen by the eyes in a peripheral region of vision.

29. The method according to claim 28, wherein applying the optical perturbations comprises applying a refractive power selected to defocus images seen by the eyes in a peripheral region of vision.

30. (canceled)

31. The method according to claim 27, wherein applying the optical perturbations comprises reducing a contrast of images seen by the eyes in a peripheral region of vision.

32. The method according to claim 27, wherein applying the optical perturbations comprises enabling clear vision by the left and right eyes in respective central zones of vision of both the left and right eyes of the user while perturbing the light that is incident peripherally on the left and right eyes in the temporal alteration.

33-47. (canceled)

48. The method according to claim 27, wherein applying the optical perturbations comprises positioning first and second optical elements having controllable optical phase profiles in respective lines of sight of the left and right eyes, and controlling the optical phase profiles to apply the optical perturbations.

49. (canceled)

50. The method according to claim 27, and comprising sensing an operating condition of the spectacles, and modifying the optical perturbations responsively to the operating condition.

51-63. (canceled)
